(19) United States
(12) Patent Application Publication
(10) Pub. No.: US 2013/0018813 A1
(43) Pub. Date: Jan. 17, 2013

(54) Computerized Net Price Calculation Method and System with Total Cost and Affordability Calculation

(71) Applicants: Craig V. Carroll, Double Bay (AU); David M. Childress, Sacramento, CA (US); Eric S. McCormack, Whitman, MA (US); Christiane Thy Nguyen, West Sacramento, CA (US); Tuongvy Dao, West Sacramento, CA (US); Misee Lee, Sacramento, CA (US)

(72) Inventors: Craig V. Carroll, Double Bay (AU); David M. Childress, Sacramento, CA (US); Eric S. McCormack, Whitman, MA (US); Christiane Thy Nguyen, West Sacramento, CA (US); Tuongvy Dao, West Sacramento, CA (US); Misee Lee, Sacramento, CA (US)

(73) Assignee: REZOLVE GROUP, INC., Sacramento, CA (US)

(21) Appl. No.: 13/184,067

(22) Filed: Jul. 15, 2011

(51) Int. Cl. G06Q 50/20

(52) U.S. Cl. 705/327

(57) ABSTRACT

A computerized method and system for conveying the affordability of an individual's choice of post-secondary educational program by determining the total cost, estimated student aid awards and net price of attending a specific academic institution. The computer system receiving a student's and their family's personal, financial, and academic information and combining that information with specific and individualized cost of attendance information from one or more academic institutions. The computer system then calculates the total cost of attending the school, the estimated net price, and out of pocket expenses based on the information provided by the student. Additionally, the computer system and method provides affordability analysis tools to help student further understand the cost of funding and repaying the cost of an educational program under various scenarios.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many academic institutions provide admission, enrollment, and cost information to prospective students via their websites. This is especially true for post-secondary institutions. The academic institutions will also often provide more detailed cost information, such as the tuition, room and board costs, and miscellaneous costs, such as books and laboratory fees, which typical students might be required to pay as a consequence of their attendance at the academic institution. Likewise, institutions will often provide general (non-student specific) information about how to apply for financial aid programs such as scholarships, loans, work-study programs, and grants that students might access while attending the academic institution.

While having this information is helpful for potential students, it does not provide a complete explanation or break-down of the prospective student's out-of-pocket or net price of attendance because each student's situation is different. Students often struggle to understand their eligibility for student aid programs because there are a wide variety of criteria used to determine awarding, which are based on the student's highly personal circumstances, e.g. personal and family income, personal and family assets, academic abilities, desired program or degree of study, state of residency, marital status, family parental situation and enrollment status, to name a few. Based on these criteria, there are a multitude of outcomes in terms of costs and eligibility for student financial aid—some students may need to finance all of their educational costs, others may only need to finance a portion or none of their education, some students will quality for substantial grants, and some will qualify for none. To address this need, many institutions provide net price calculators to prospective students. These software systems provide prospective students with personalized net price estimates. They often take into account the students' unique characteristics, the institution's unique financial aid offerings as well as the student's eligibility for federal, state and/or military student aid.

Nevertheless, with a multitude of funding sources such as loans, grants, scholarships, and work-study programs, it can be difficult for prospective students to develop a clear understanding of the real costs of attending an academic institution and the overall affordability of an institution's educational programs. Likewise, it is even more difficult understand future costs of attendance for the multiple years required to obtain a degree, and thereafter and also to find the right balance between accessing student and parental/family loans and utilizing their own savings or borrowing money from friends and family.

### SUMMARY OF THE INVENTION

Without a clear understanding of an individual's eligibility for specific student aid programs, near-term, and long-term costs, students and their families are unable to either a) receive personalized insight as to the individual affordability of an educational program prior to applying and being admitted, or b) make educated decisions regarding the affordability of an academic institution/educational program. This knowledge gap causes many students/families to make suboptimal decisions about pursuing a post-secondary education; some students may not even pursue a post-secondary education mistakenly thinking that the institution's published (“sticker”) price was too expensive for them to afford. This scenario is detrimental to both the educational institution and potential students because students may elect not to apply to preferred institutions they otherwise would have considered and the institution may forfeit potential students.

The present invention is directed to a computer system and computerized method that combines cost information of specific educational programs at particular post-secondary institutions with detailed personal and financial aid information about potential students (and their family) to provide a detailed and comprehensive analysis of an individual student's specific eligibility for student aid programs, the net price of attending the institution, the total cost of a selected degree, post-graduation debt burden, and monthly loan repayment estimates so prospective students can fully assess the affordability of a certain educational program at a certain institution and determine if it is a good fit for their personal circumstances, their career interests and likely future earning capacity.

The computer system and computerized method also provide interactive tools that allow potential students and associated family members to adjust funding sources to experiment with different funding scenarios in order to gain a better understanding how to finance and repay their education.

In general, according to one aspect, the invention features a computerized method for determining the total cost of attending an academic institution to obtain a degree. The method includes entering the student's and family-relevant personal academic and financial information into a user interface generated by a computer system and determining and displaying the estimated student aid awards and net price per academic year (or per academic term) based on the student's personal circumstances. The method further includes generating an estimated total loan amount for the candidate to complete the educational program based on the first year financial aid loan amount(s) and a compounded annual growth rate, and displaying the estimated total loan amount along with estimated monthly loan payments that are calculated based on the estimated total loan amount.

In general, according to another aspect, the invention features a computer system for determining the total cost of attending an academic institution to complete the educational program. The computer system receives candidate information via a user interface displayed on a screen of a computer system. Further, the computer system determines and displays the estimated student aid awards and net price per academic year (or per academic term) based on the candidate's personal circumstances such as academic merit and personal and family financial information and generates an estimated total loan amount for the candidate to obtain the degree based on the first year financial aid loan amount and a compounded annual growth rate. Lastly, the computer system displays the estimated total loan amount along with estimated monthly loan payments that are calculated based on the estimated total loan amount.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. Of the drawings:

FIG. 1 is a block diagram illustrating an overview of the relationship between potential students or candidates, the academic institution's website, the computer system for calculating net price of attendance, and additional academic computer systems.

FIG. 2 is a flow chart illustrating the steps performed by the computer to calculate the total cost of attendance at specified academic institutions.

FIG. 3 shows an exemplary welcome screen displayed to candidates and provides introductory information about the net price calculator and survey that is generated as part of a user interface by the computer system.

FIG. 4 shows an exemplary registration screen that candidates must complete before beginning the survey that is generated as part of a user interface by the computer system.

FIG. 5 shows an exemplary personal information screen that requires the potential student to enter information family information about dependency and military service information that is generated as part of a user interface by the computer system.

FIG. 6 shows an exemplary a personal information screen that requires the potential student to enter additional personal information related to the potential student's citizenship, residency, and their high school that is generated as part of a user interface by the computer system.

FIG. 7 shows an exemplary academic information screen that requires the potential student to enter information about academics that is generated as part of a user interface by the computer system.

FIG. 8 shows an exemplary academic information screen that requires the potential student to enter information about their academic performance to aid in calculating merit-based financial aid that is generated as part of a user interface by the computer system.

FIG. 9 shows an exemplary financial information screen that requires the potential student to enter financial information that is generated as part of a user interface by the computer system.

FIG. 10A shows an exemplary net price calculator results screen provides an overview of estimated cost of attendance for specified academic institutions that is generated as part of a user interface by the computer system.

FIG. 10B shows a portion of an exemplary net price calculator screen that includes a tuition discount as part of the total cost of attendance.

FIG. 10C shows an exemplary pie chart that is generated based on the total cost of attendance and estimated aid sources to fund the total cost of attendance for the potential student.

FIG. 10D shows an exemplary financing your education screen that provides information on estimated cost of attending specified academic institutions and estimated monthly payments upon graduation that is generated as part of a user interface by the computer system.

FIG. 10E shows an exemplary financing your education screen for an institutional payment plan based on the entire duration of a program or degree.

FIG. 10F shows an exemplary personal affordability analysis screen that allows a potential candidate to test additional funding scenarios related to the cost of attending academic institutions that is generated as part of a user interface by the computer system.

FIGS. 10G-10I show examples of changes made to entry fields within the user interface that is generated as part of a user interface by the computer system.

FIG. 10J shows an exemplary personal affordability analysis screen that additionally allows a potential candidate to enter existing loan amounts and corresponding interest rates according to another embodiment.

FIG. 11 is a flowchart that shows the steps performed by the computer system and net price calculator engine to determine the net price calculation.

### DETAILED DESCRIPTION OF THE PREFERRED EMBODIMENTS

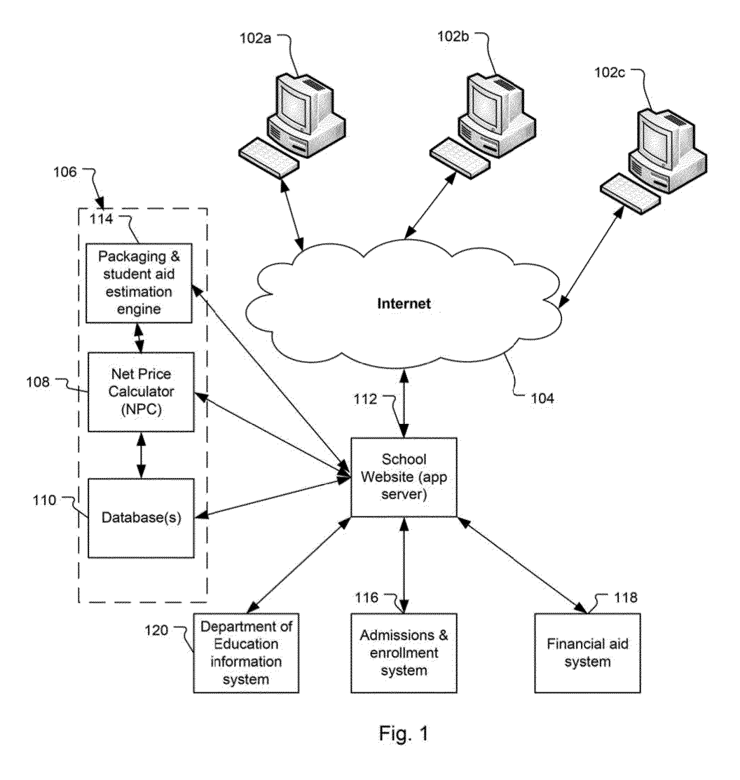

FIG. 1 illustrates an overview of the relationship between potential students 102a-c, the academic institution's website 112, the computer system 106 for calculating net price of attending an academic institution, and the potential integration with institutional computer/student aid information systems such as an admissions computer system 116 and a financial aid and/or bursar's computer system 118.

In a typical implementation, potential students or candidates 102a-c use personal computers, laptops, tablet devices, or smart phones to access an academic institution's website 112 via a computer network such as the Internet 104. In a preferred embodiment, the potential students 102a-c use internet browsers to navigate to a website either hosted by the academic institution or by a third party. In an alternative embodiment, the potential student may access the school's website from a computer terminal or kiosk located on the institution's campus.

A graphical user interface is presented to the potential students 102a-c by the computer system 106 preferably as series of served web pages. The graphical user interface guides the potential students through a series of screens that display information, directions, and questions that are part of a survey that needs to be completed by the potential student. The data from the survey enables a student aid estimation engine 114 of the computer system 106 to determine a student's eligibility for various types of aid programs.

A net price calculator engine 108 is a software program executed by the computer system 106 that calculates the cost and net price of attendance. Additionally, the information entered by the potential students is transferred to a database(s) 110 to enable the academic institution and potential students to access, edit, review, and delete the information at a later time.

In alternative embodiments, if the candidate previously applied to or currently attends the academic institution, then the candidate's personal information, academic information, and financial information is parsed from the other computers system 120, 118, 116 and loaded to the computer system 106. Similarly, the information obtained during the survey is able to be transferred to the Department of Education information system 120 typically as part of a Free Application for Federal Student Aid (FAFSA), admissions and enrollment system 116, or financial aid system 118.

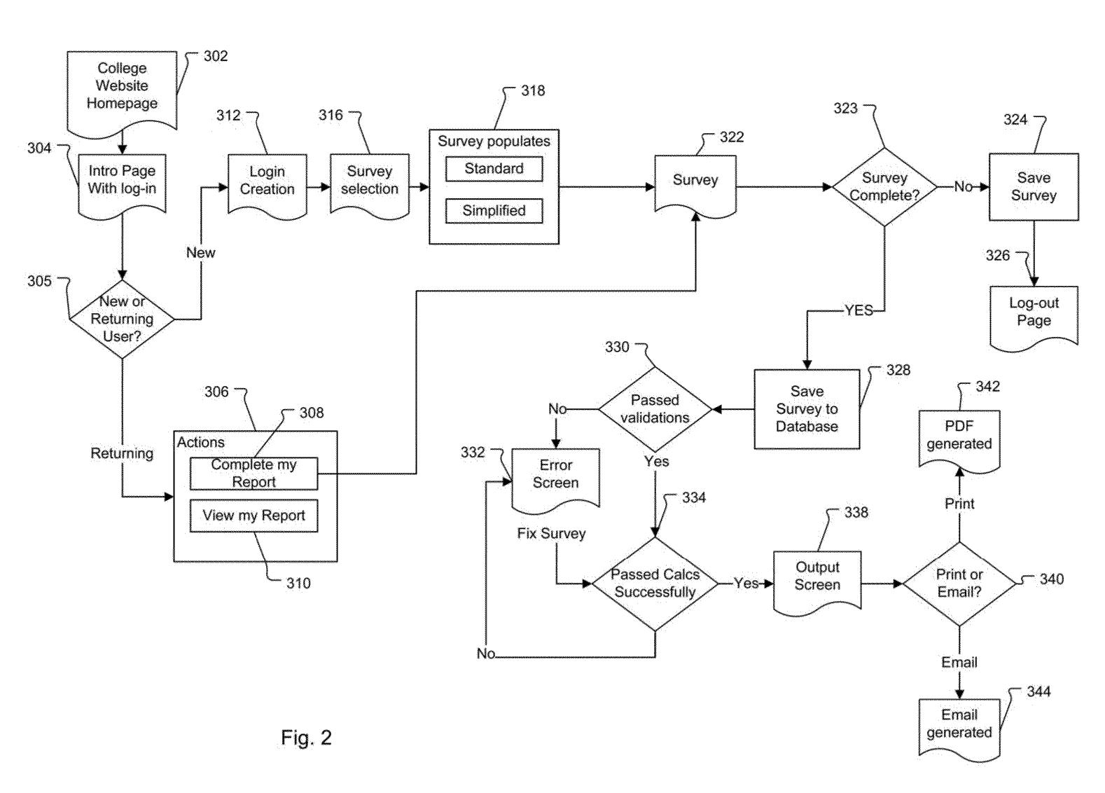

FIG. 2 is a flow chart illustrating the steps potential student and computer must complete to calculate the total cost of attendance at specified academic institutions.

In the first step 302, a potential student or candidate uses a computer 102 to navigate to a website hosted by an academic institution or by a third party and specifically application server 112. In an alternative embodiment, the student navigates to a website hosted by a third party that accesses information from multiple academic institutions and presents multiple calculations for different academic institutions simultaneously.

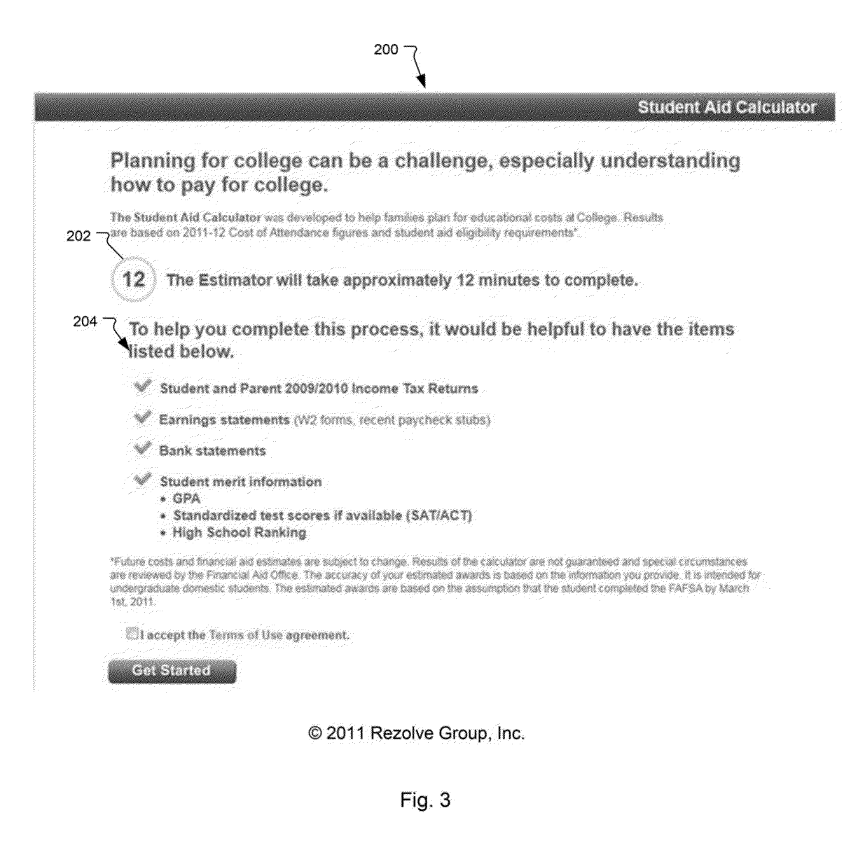

The computer system 106 presents an introduction page (see FIG. 3) that provides information about the net price calculation, how long the survey takes to complete, and other documents that would be a helpful reference while completing the survey, in step 304.

In the next step 305, the computer system 106 enables returning users to log into a previous account. Returning users are presented with a returning users screen in step 306. The returning users are able to complete a previous survey in step 308 or view an already completed survey in step 310. If the candidate needs to complete a survey, then the computer system 106 obtains their partially completed survey data from the database 110 and allows the user to complete the survey from wherever they stopped in step 308.

If the candidate is a new user then the computer system 106 requires the candidate to register and create a login in step 312. In the next step 316, the candidate selects either a simplified or standard survey to complete. The simplified survey has fewer questions and requires less time to complete, but the net price calculations may not be as accurate. In an alternative embodiment, additional survey could be added or removed based on the needs of the academic institution. In an alternative embodiment, data that were populated on the institution website or through the Department of Education are transferred to the data intake survey to streamline the student experience of calculating their student aid eligibility and receiving their net price estimate.

In the next step 318, the student populates the appropriate survey based on whether the potential student chose a simplified or standard survey or if the institution provided an option to the student. In step 322, the candidate completes the survey by entering information such as personal information, financial information, expected family contributions (if known), and academic achievement information, to list a few examples.

In the next step 323, the computer system 106 determines if the survey has been completed. If the survey has not been completed, then progress is saved in step 324 and the computer system presents the logout page in step 326.

If the survey is complete, then the computer system 106 saves the survey to the database 110 in step 328. In the next step 330, the computer system 106 performs an error check to ensure that valid information has been entered into the computer system based on field level and survey level validations rules that are built in and maintained. For example, field level validation is performed such as checking that an email address is properly formed, or that letters have not been included when entering a telephone number. Additionally, the computer system 106 also checks to ensure that no conflicting information has been entered and performs survey level validations. For example, the system ensures that a candidate does not enter zero dependants, then later enter that they have two dependents. This error check also takes into consideration federal regulations to prevent the user from answering a question that is not possible/allowed based on the established federal methodology for calculating an expected family contribution.

If there are errors, then the computer system 106 presents an error screen in step 332 and the candidate is required to fix the errors before proceeding to the next part of survey. In the next step 334, the computer system performs calculations based on the information entered by the candidate. If the calculations did not pass verification, then an error screen is presented. If the calculations did pass verification, then the candidate is directed to an output screen in step 338.

Lastly, the candidate is able to have their results mailed via email to the potential student's email address or presented as a downloadable document in step 340. If the candidate selects the email option, then the computer system 106 generates an email with the total cost, estimated student aid awards, and net price calculations in step 344. If the candidate selects the print option, then the computers system presents a downloadable PDF document or a print friendly HTML version of the results in step 342 that may be downloaded by the potential student. Additionally, the computer system includes the ability to control content delivery based on rules established by the institution.

Examples of the rules established by the institution include displaying dynamic content to incoming freshman only or to students who meet eligibility for a particular financial aid program, or students who are likely to qualify for an institutional Honors Program based on a combination of their academic criteria and personal circumstances, to list a few examples.

FIG. 3 shows an exemplary welcome screen 200 displayed to potential students and provides introductory information about the net price calculator and survey. The academic institution has the option to collect a detailed or simplified data set from the potential student. In an alternative embodiment, the prospective student would have the ability to choose the survey they would prefer to complete. The variable survey selected determines the length of time it takes to complete the survey.

The welcome screen provides introductory information about the net price calculator, how long the survey takes 202, and a reminder 204 of documents that would be helpful to the student while completing the survey.

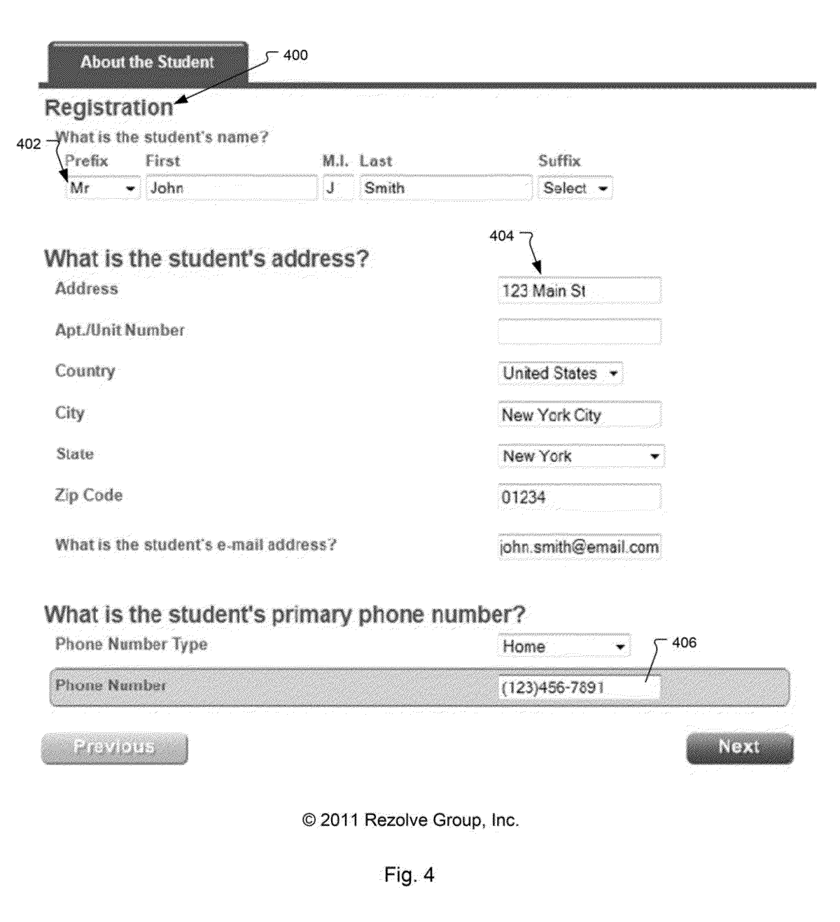

FIG. 4 shows an exemplary registration screen 400 that is optional. Potential students are not required to complete this section before beginning the survey.

In a typical implementation, the potential students enter personal information into the computer system 106. The personal information includes name 402, and contact information 404 such as address, country, city, state, zip code, email address, and phone number 406. If the potential students had previously registered, then the potential student is not required to re-enter their personal and contact information.

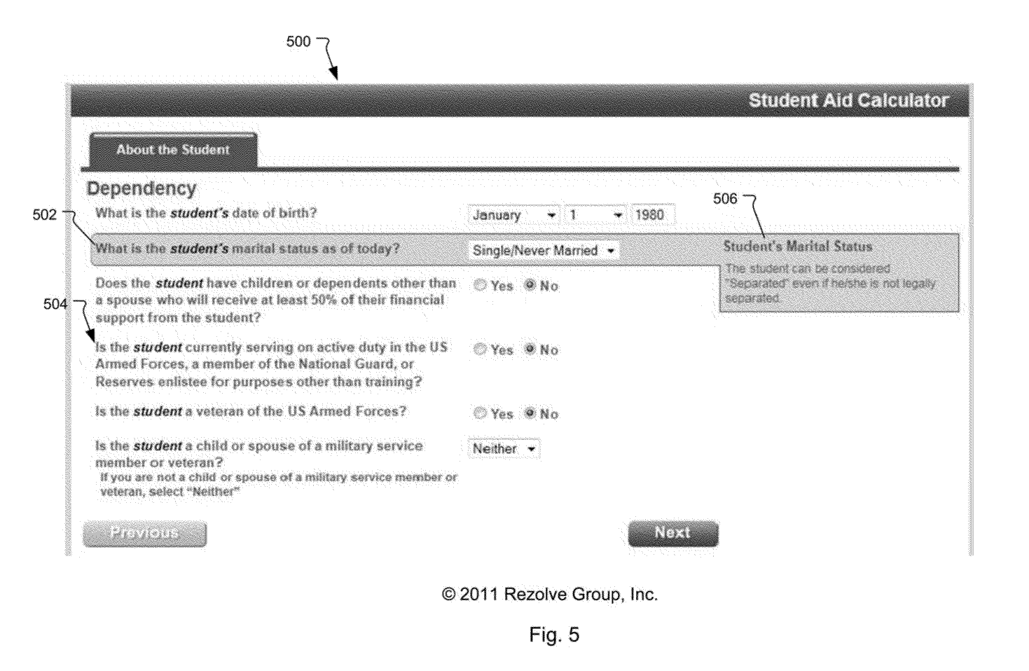

FIG. 5 shows an exemplary personal information screen 500 that requires the potential student to enter information to determine dependency status as defined by the Department of Education such as the student's date of birth, if the student has dependents and if the student is/was serving in the U.S. military service. In a typical implementation, the potential student is required to list their marital status 502, as well as questions about their military service 504. Additionally, a help box 506 is displayed to provide additional guidance to the potential student while they complete the survey.

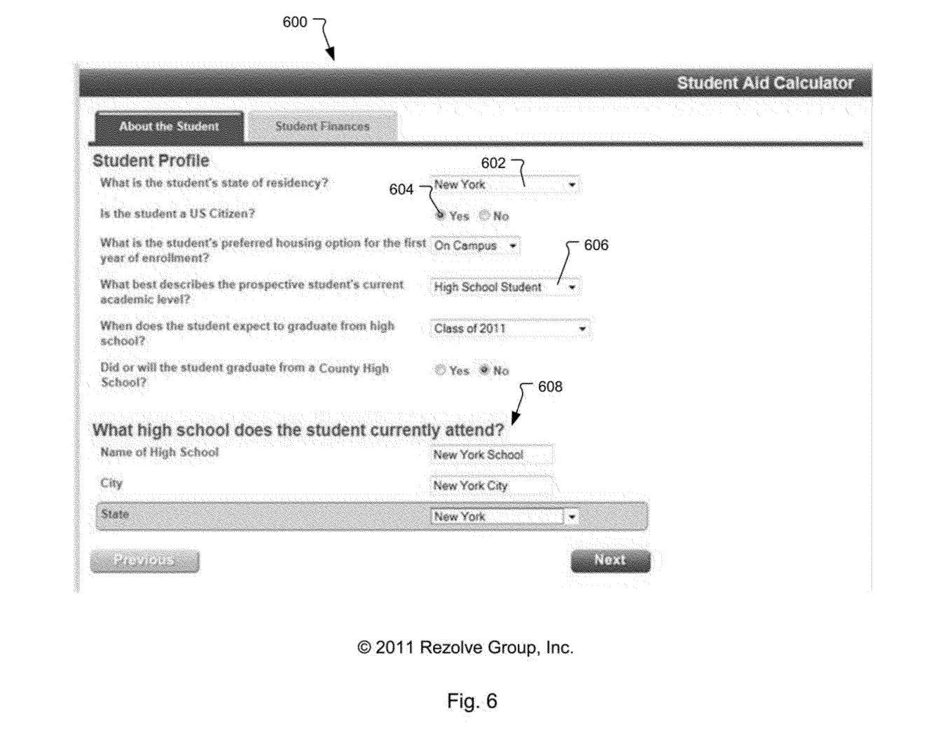

FIG. 6 shows an exemplary a personal information screen 600 that requires the potential student to enter additional personal information related to the potential student's citizenship, residency, and their high school. The questions displayed to the potential student vary based on the required eligibility criteria for applicable student aid programs at each institution.

The potential student is typically required to enter a state of residency 602 and whether they are a United States Citizen 604. Likewise, the potential student is required to enter the highest level of education achieved 606. If the student is still in high school, then the computer system 106 requests the potential student to provide the name of the school and the state where the high school is located 608.

Preferably, the potential student is required to select the desired campus and program of study. This is typical for academic institutions that are spread across multiple campuses and offer a range of program of studies based on campus. The combination of campus selection and program of study drives the total cost of attendance. The academic institution is able to determine eligibility for financial aid programs based on the campus and program of study selection.

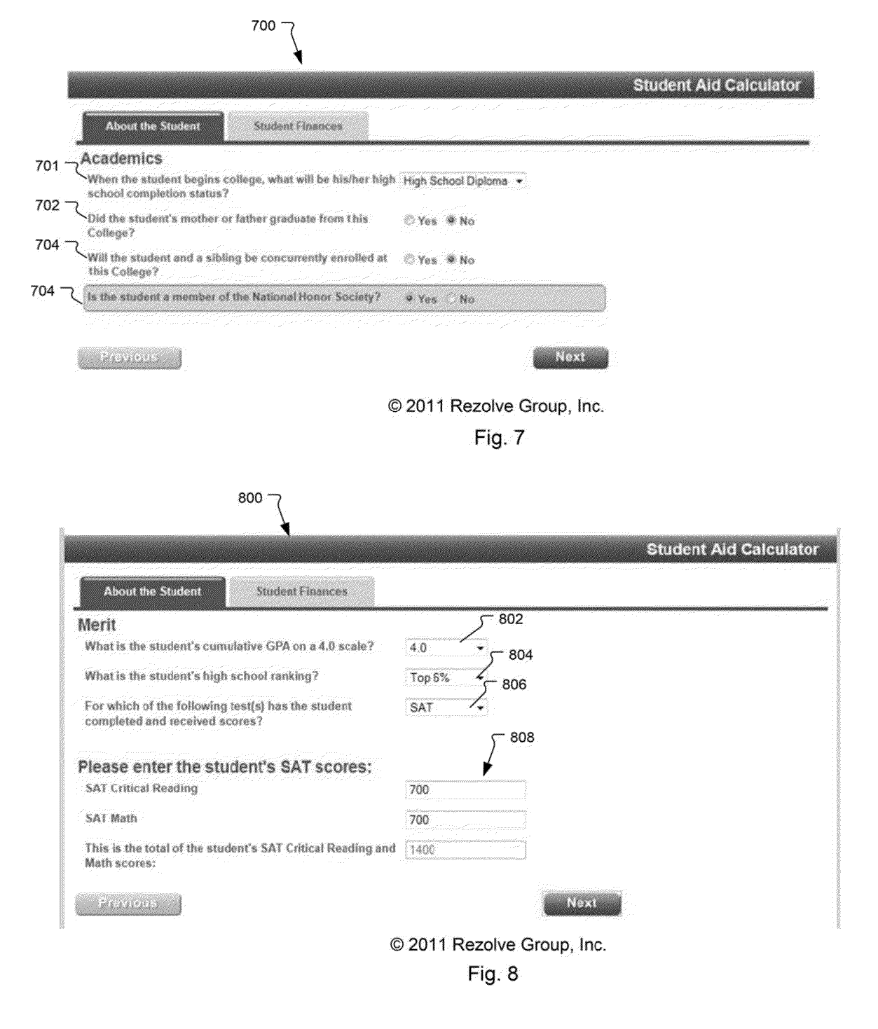

FIG. 7 shows an exemplary academic information screen 700 that requires the potential student to enter information about academics. In the example provided, the potential student is required to enter academic completion status 701, whether their mother or father graduated from this college 702, whether a sibling will be concurrently enrolled at this college 704, and whether the potential student is a member of the National Honor Society 704. The question set displayed on this page is typically customized by academic institution. Any additional academic requirements necessary to receive institution specific aid are included in this section. These factors help the academic institution determine eligibility for need- and merit-based financial aid programs and vary in each embodiment of the software and computer system developed for different institutions.

FIG. 8 shows an exemplary academic information screen 800 that requires the potential student to enter additional information about their academic performance to help the student aid estimation engine 114 to calculate merit-based financial aid. The potential student is required to enter information about their grade point average (GPA) 802, the student's ranking in high school 804, and whether the student has taken the ACT and/or SAT tests 806 and their scores for the test 808. If there are additional merit requirements necessary to receive institution specific aid, the academic institution can choose to customize their question set and add it to this page or any page within the survey.

These compilations of information and scores enable the computer system 106 and student aid estimation engine 114 to be able to determine if potential students meet the basic requirements to qualify for any merit-based grants, scholarships, or loans.

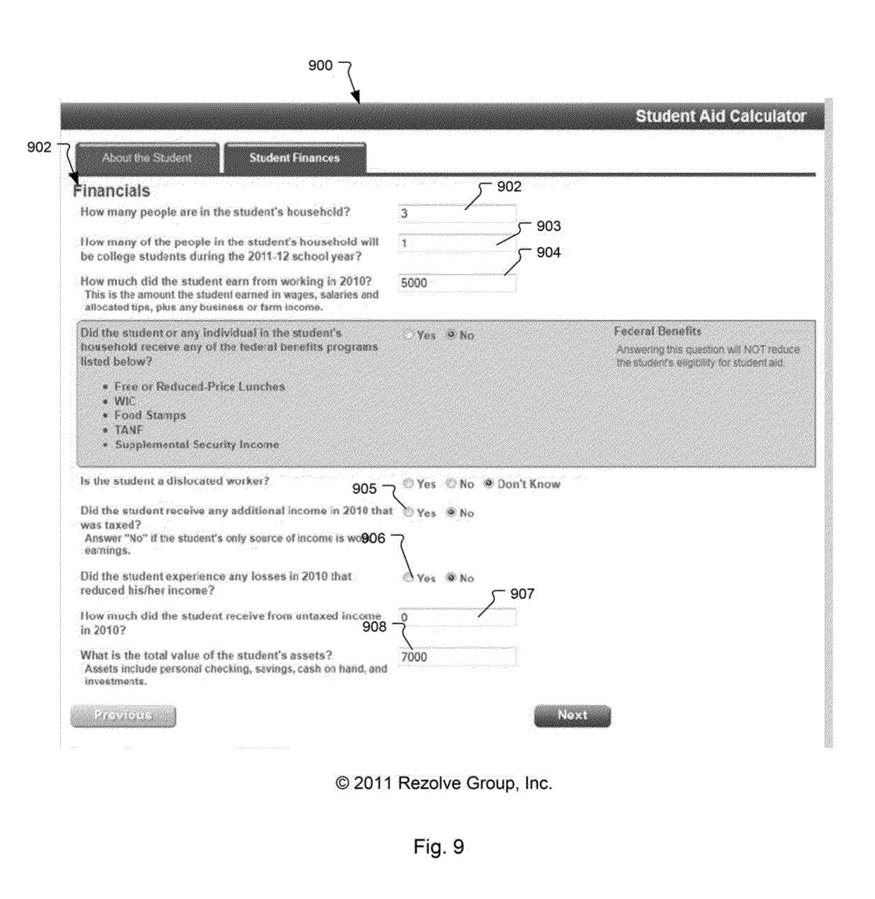

FIG. 9 shows an exemplary financial information screen 900 that requires the potential student to enter financial information. If the student is a dependent student by the definition promulgated by the Department of Education, then the questions listed would be directed towards the student's parent(s).

The potential student is required to enter how many people are in the same household as the potential student 902 and how many of people in the household will be attending college in the academic year 903.

The potential student is also required to enter how much money they made in income 904, as well as additional income 905 (for example, interest from bank accounts or investments), financial losses (for example, losses to investments), untaxed income 907, and the total value of the potential student's assets 908.

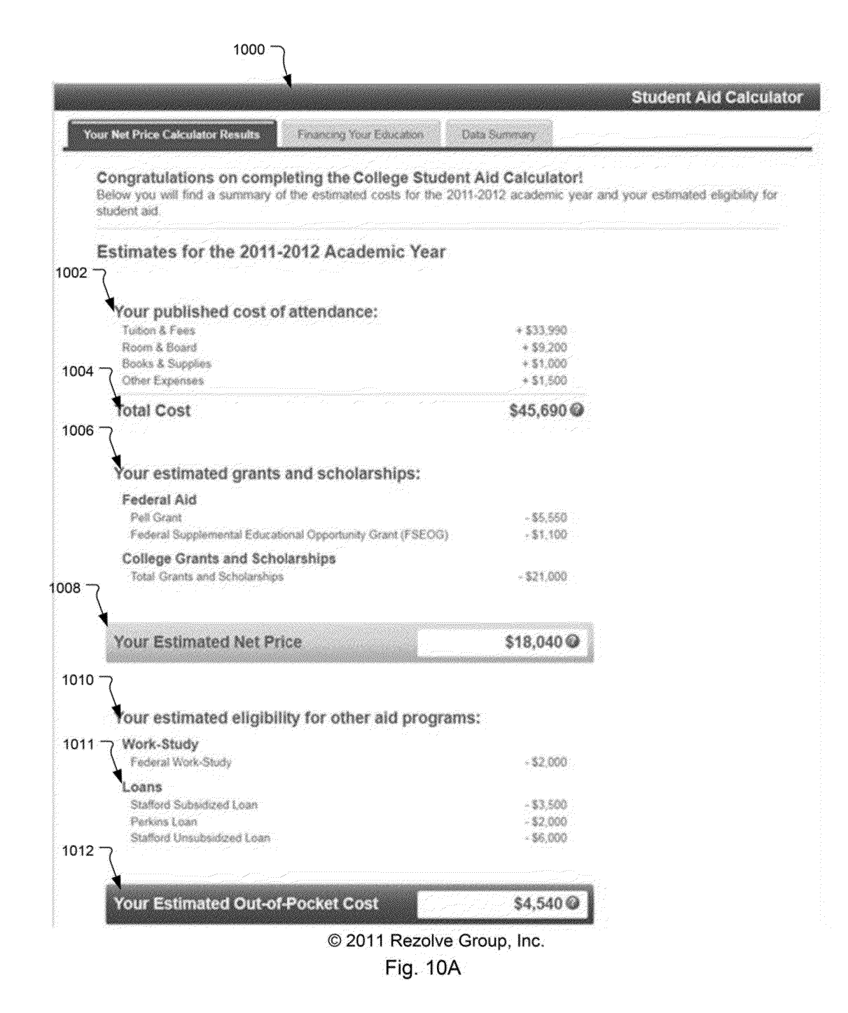

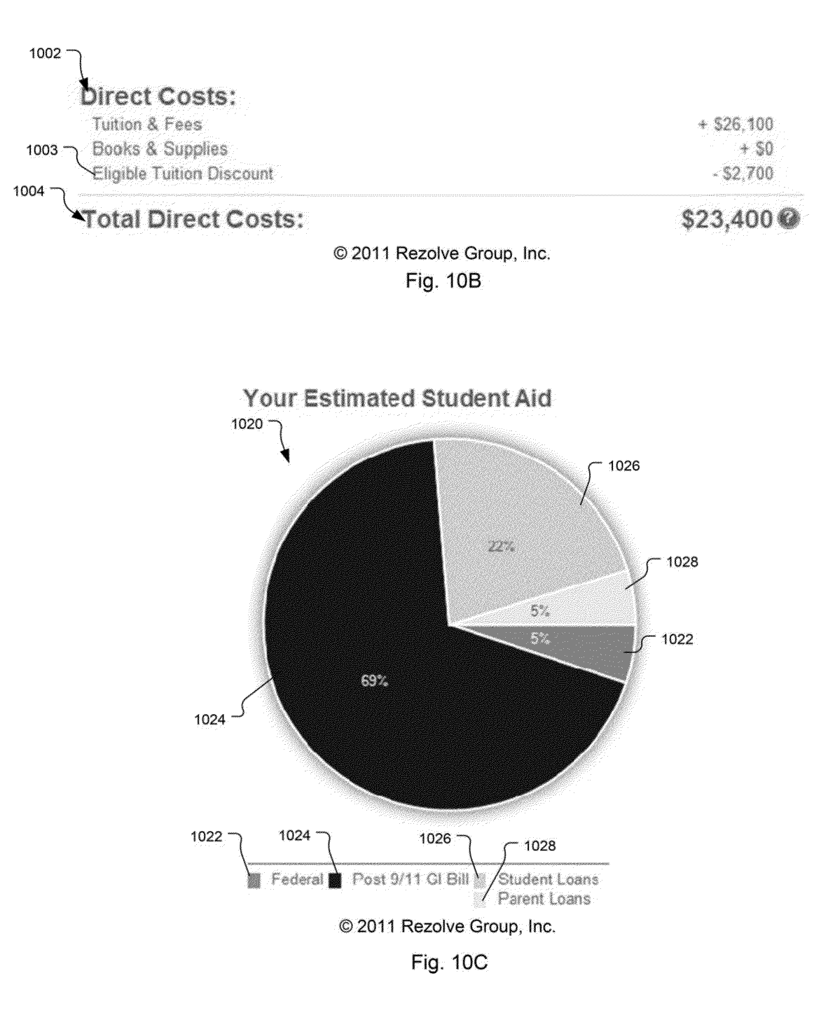

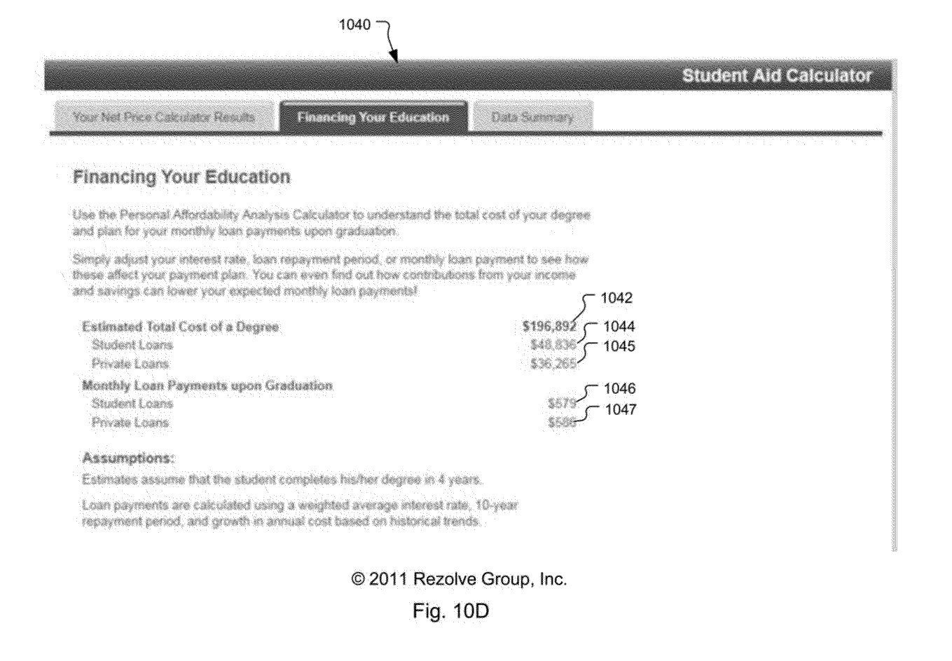

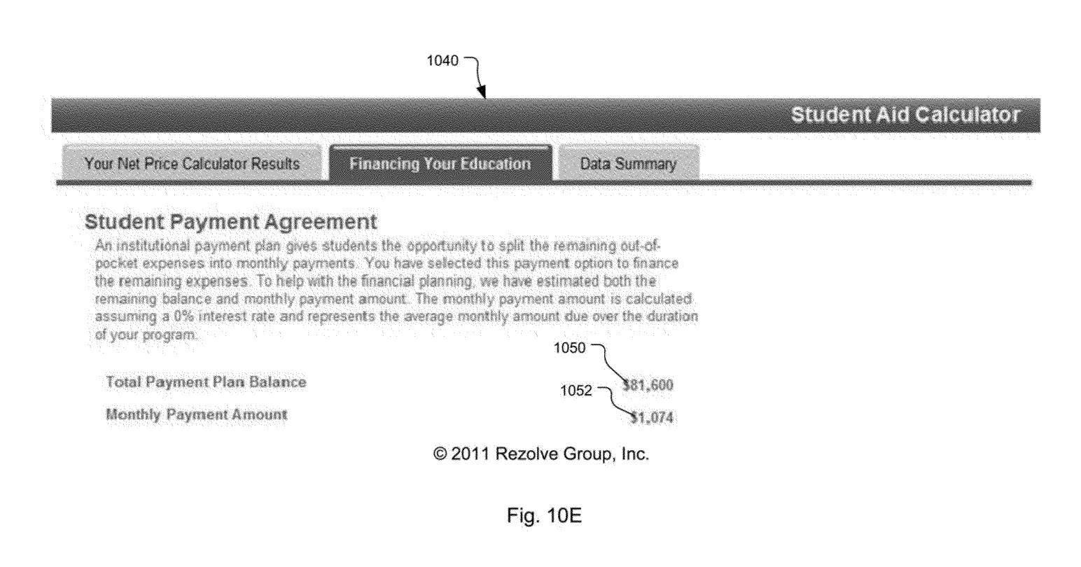

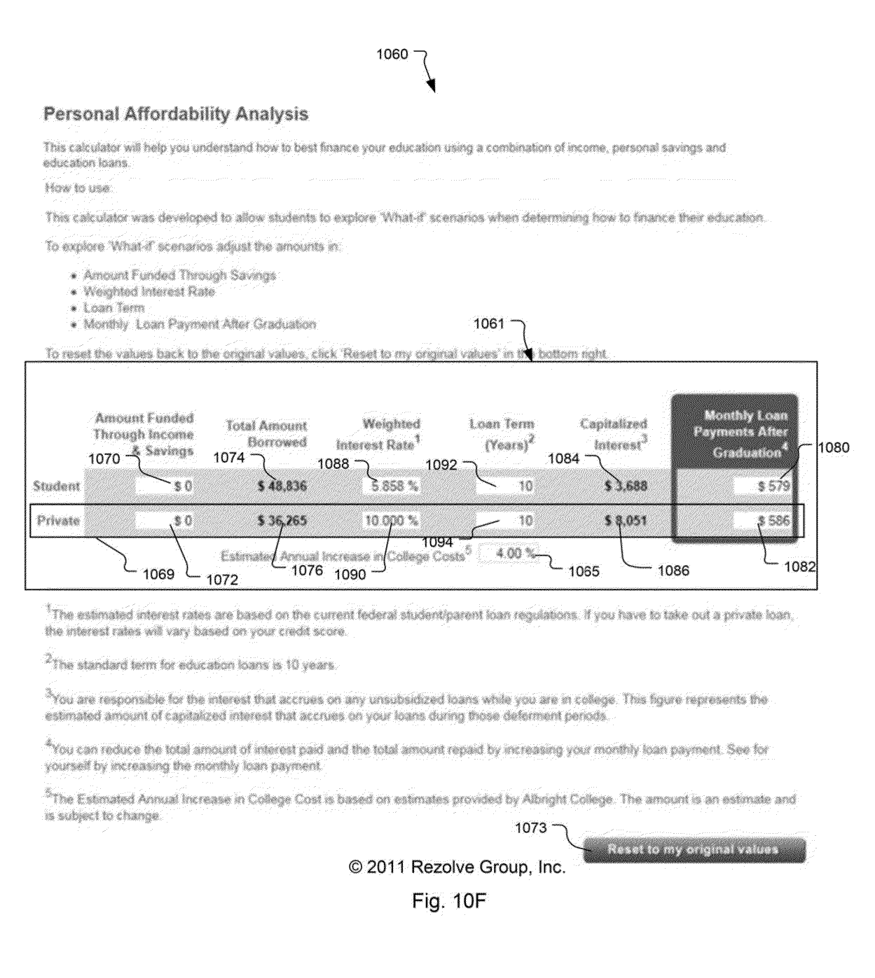

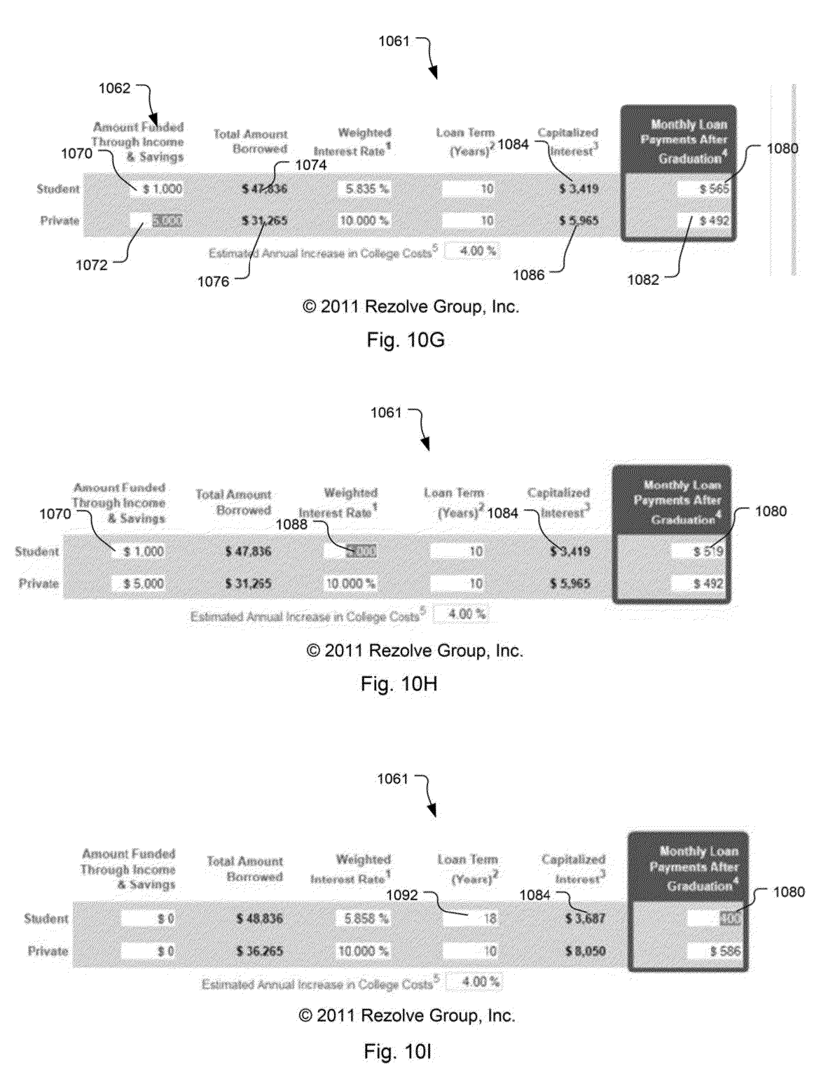

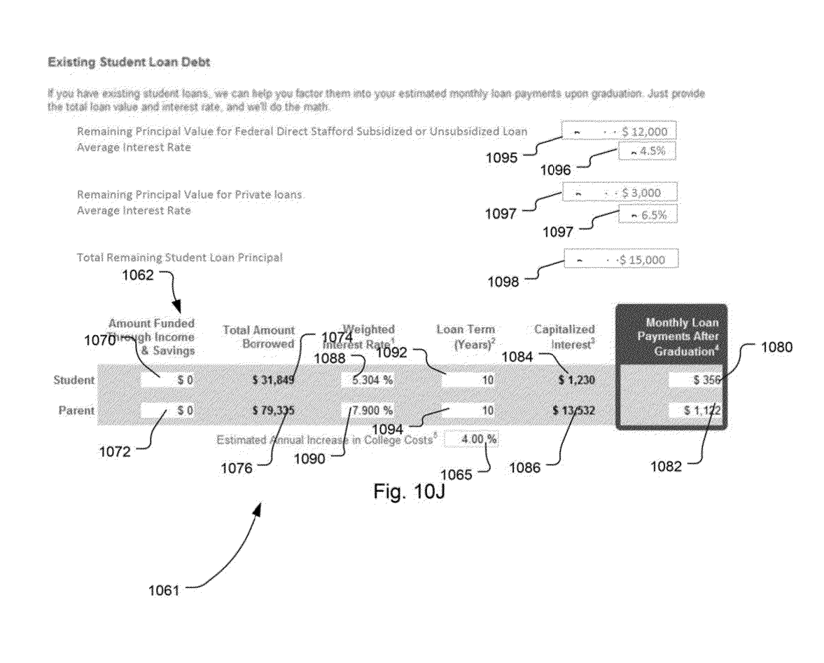

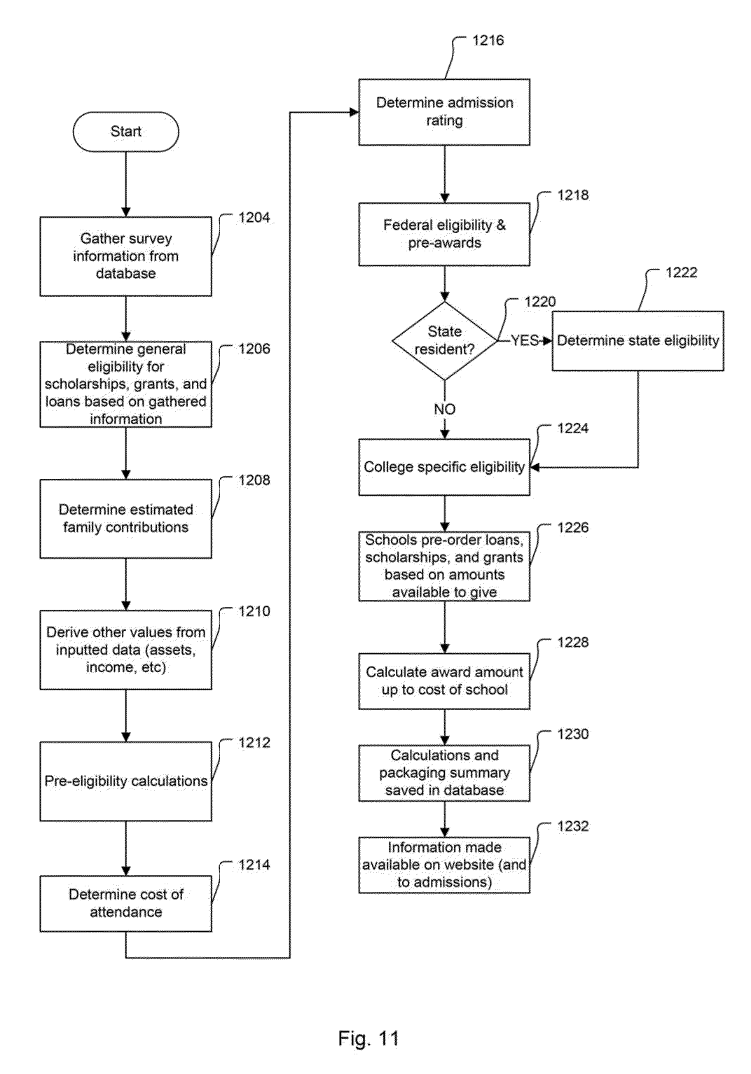

FIG. 10A shows an exemplary net price calculator results screen 1000 that provides a detailed overview of the estimated cost of attendance for specified academic institutions. The estimated cost of attendance can vary for potential students at the same academic institution. For example, it can vary for in-state/out-of-state residents, by program of study, and grade level. The results page is fully customizable and built in a modular fashion that allows the institution to control the content, design, and display of student aid eligibility and net price.

The computer system 106 displays the published cost of attendance 1002. The published cost of attendance 1002 includes tuition and fees, room and board, books and supplies, and other expenses. In an alternative embodiment, the computer system 106 is able to include a breakdown of what each expense includes as well as additional expenses students are likely to have, such as personal costs, transportation and/or parking costs, and insurance costs, to list a few examples. The result is the total cost 1004 for the academic year or total program of study. In examples, the total cost of attendance and eligibility for different sources of student aid are also graphically represented in the form of a pie chart (see FIG. 10C).

The student aid estimation engine 114 calculates the potential student's expected family contribution (EFC). The academic institution uses the EFC to determine need (total cost minus EFC) and impacts the amount of need-based student aid the potential student may receive. There are two methods to calculate an EFC: the federal methodology as defined by the Department of Education and a modified methodology. Some academic institutions apply modifications to the federal method to award their college-specific awards. If the potential student plans to enroll in a program with academic years that are less than 9 months (commonly for non-term programs), the EFC is prorated. Once the EFC is calculated, the student aid estimation engine 114 of the computer system 106 then calculates the potential student's estimated grants and scholarships 1006. The computer system 106 displays the federal (including military education benefits), state and institution-specific financial aid for which the potential student qualifies and will likely receive if they apply to the academic institution. The computer system 106 then displays the estimated net price 1008. The estimated net price 1008 is the total cost of attendance 1004 minus federal and state grants and scholarships 1006.

In some cases, the student aid estimation engine packages aid awards up to the direct cost of attendance. The direct cost of attendance generally includes tuition and fees and occasionally books and supplies. For institutions with on-campus housing options, it may also include room and board charges. The estimated grants, scholarships and net price are graphically represented in the form of a pie chart, in some examples.

The computer system 106 then calculates estimated eligibility for other financial aid programs 1010, which typically includes work-study, loans, and self-reported outside scholarships. Lastly, the computer system 106 then calculates the estimated out-of-pocket cost 1012. Out-of-pocket cost 1012 represent the amount of ‘day one’ or ‘up front’ money the student and/or family is expected to pay after all student aid sources have been funded. The out-of-pocket cost 1012 is the estimated net price 1008 minus the sum of work-study, loans and self-reported outside scholarships. In examples, the estimated eligibility for other financial aid and remaining out-of-pocket cost are graphically represented in the form of a pie chart (See FIG. 10C).

FIG. 10B shows a portion of an alternative embodiment of the exemplary net price calculator screen 1000 that includes a tuition discount 1003 as part of the total cost of attendance 1004.

The total cost of attendance 1004 often varies for targeted populations at the discretion of an academic institution. Academic institutions will typically have academic, athletic, or economic discounts available for potential students who qualify for a reduced cost of attendance. The tuition discount 1003 is applied to the total costs 1004. In an alternative embodiment, the discount is applied to just the costs associated with tuition and fees. In the preferred embodiment, the institution can to make changes and manage the computer system 106 to, for example, edit prices and programs weekly—the system is flexible to allow for these changes.

FIG. 10C shows an exemplary pie chart 1020 that is generated based on the total cost of attendance 1004 and estimated aid sources 1010 to fund the total cost of attendance for the potential student.

The award amount for each aid source is divided by the total cost of attendance to calculate percentage of cost. The pie chart 1020 provides a visual representation of the results of the net price calculation. The graphical representation illustrates various funding sources as well as the proportion of the total each funding source represents. The pie chart 1020 is a useful tool to help potential students visualize their funding sources.

Thus, in the exemplary pie chart, a potential student is able to see that the majority of the cost of attendance is funded with the post 9/11 G.I. Bill 1024 and student loans 1026. And additional funding also includes federal work-study 1022 and parent loans 1028. This chart is dynamically generated based on the types and sources of aid that are available at an institution.

FIG. 10D shows an exemplary financing your education screen 1040 that provides information on the total cost of obtaining a degree 1042, estimated loans accumulated 1044, 1045, and the estimated monthly loan payments upon graduation 1046, 1047. In an alternative embodiment, students will have the option to choose how they would like to fund their out of pocket expenses via a private loan, institutional payment plan, or parent (PLUS) loan (for dependent students only).

In a typical implementation, the computer system 106 determines the duration of the degree or program based on the program of study selected by the potential student. The net price calculator 108 factors in historical cost increases such as inflation, annual tuition increases, and annual room and board increases to calculate the compounded annual growth rate. In an alternative embodiment, the computer system 106 calculates and displays calculations for students that complete their degree in longer or shorter lengths of time, continuing students who have prior student loans, students who attend multiple academic institutions, and students who obtain multiple or joint degrees. Additionally, for transfer students the computer system 106 accounts for the transfer credits allowable to determine the remaining program duration for the potential student and calculate the total cost of degree.

Also, potential students who elect to attend part-time or less than full-time will have varying program lengths to complete a degree. The computer system 106 factors in the number of credits completed per academic year and duration of the program to determine the total cost of degree.

The total cost of the degree 1042 is calculated by summing the total cost of attendance for one year 1004 with the extrapolated future costs increases for each additional year. The cost increases are represented as a numerical percentage referred to as the compound annual growth rate which is configurable. The computer system 106 uses an annual growth rate based on historic trends of cost increases at the academic institution, determining an annual growth rate that represents those costs increases, and applying the annual growth rate to the cost of attendance 1004. The computer system 106 then repeats the calculation process for the additional years required to obtain the degree.

The financing your education screen 1040 displays the total amount of student loans 1044 the student is likely to accumulate in 4 years at the academic institution. The number of years that is displayed is based on the degree duration and expected time to complete a degree at each institution. This number is based on one-year loan amounts 1011 generated and displayed in the Net Price Calculator results screen 1000 and extrapolated over the term of the selected degree program. The amount of money a student needs to fund their education is directly related to the cost of attending the academic institution. For this reason, the computer system 106 performs a similar annual growth rate calculation to determine the additional amount of student loans 1044 a student needs to fund their education for the length of the degree program. Borrowing limits are applied to the Stafford Direct loans based on an annual basis, as determined by the lifetime aggregate Stafford loan borrowing limits. For example, at the time of this writing, a freshman dependent student can borrow up to $3,500 for the Stafford subsidized/Direct loan and an additional $2,000 for the Stafford unsubsidized loan. Sophomores can borrow up to $4,500 for the Stafford subsidized loan and an additional $2,000 for the Stafford unsubsidized loan. Junior and senior year Stafford unsubsidized awards are increased by $2,000. In determining the student's total loan amount, the borrowing limits are applied to prevent the over-awarding of student loans.

The financing your education screen 1040 also includes the total estimated amount of parent loans likely to be accumulated in the years the student attends the academic institution for dependent students. Parent loans, are loans typically borrowed by parents (not the students) to help fund their child's education. Parent loans are calculated for dependent students and Private loans are calculated for independent students. In an alternative embodiment, the prospective student will have the option to choose which funding option they would prefer for their out of pocket expenses. The results page adjusts dynamically based on the user's selection.

Typically, parent loans are commonly used to help fund their child's education because Perkins, Stafford unsubsidized, and Stafford subsidized loans all have yearly (and lifetime) maximums on the amount that can be borrowed. Moreover, the limits are often less than the amount needed to completely cover the cost of attendance. Thus, some students and their families require additional funding sources to fund the cost of education. Generally, parent loans 1045 are calculated by determining how much a student still needs after subtracting all the other funding sources such as grants, scholarships, Perkins and Stafford loans, and out of pocket expenses.

Similar to the methodology for determining the cost of attendance and student loan increases, to determine the total parent loans the compound annual growth rate is applied to the amount needed for the first year and then extrapolated for each additional year needed to complete the degree program at the academic institution.

The financing your education screen 1040 also displays the estimated monthly loan payments 1046, 1047 upon graduation. The estimated monthly loans 1046, 1047 are based on a weighted interest rate, a ten year term (the default repayment term), and growth in annual costs based on historic trends.

The weighted interest rate is determined by factoring the amount or principal of each loan and the interest rate of the loan to determine a blended interest that reflects the different sizes and interest rates of each loan. Each loan: Stafford unsubsidized, Stafford subsidized, Perkins, and parent (PLUS) loans, all have fixed interest rates that are locked in by the students at the time of borrowing the loan. For example, (at the time of writing this document) Perkins loans have a fixed interest rate of 5%, Stafford unsubsidized loans (both have a fixed interest rate of 6.8%, and parent loans have a fixed interest rate of 7.9%. Stafford subsidized loans vary based on the academic year they were disbursed. These interest rates are configurable and may adjust based on federal regulations. Should a student choose to fund their out of pocket expenses with institutional payment plans or alternative/private loans, those options will be displayed to the end user.

The computer system 106 calculates the weighted interest rate by determining the product of each loan amount multiplied by each loan's the interest rate. Next, the computer system 106 sums the total of the products and divides that amount by the sum of all the loan amounts. The computer system uses a weighted interest rate when calculating the repayment amounts 1046, 1047 to more accurately predict the monthly loan payments upon graduation.

The computer system 106 calculates the capitalized interest accrued over the life of the loans (for the student and parent). For example, the Stafford unsubsidized loan has an interest rate of 6.8% that starts to accrue after the first disbursement of loan funds. Payment on this loan is deferred until 6 months after the student graduates. Over this time period, the interest is capitalized and added to the principal loan amount to determine the total loan value to be repaid by the borrower.

The computer system 106 then determines a monthly payment upon graduation by compiling the total loan amounts 1044, 1045, the weighted interest rate (see: 1064, 1088, 1090 in FIG. 10C), and the loan term to an amortization algorithm to determine how much the monthly payments need to be to fully repay the loans by the end of the repayment period.

In an alternative embodiment, the computer system 106 displays the total cost to obtain the degree 1042, total loans accumulated 1044, 1045, and monthly loan payments 1046, 1047 as ranges. The academic institution may opt to have the computer system 106 always display ranges regardless of the type of survey completed so that students are presented with a range of best and worst case scenarios for the cost and funding of their education.

FIG. 10E shows an alternative embodiment of an exemplary financing your education screen 1040 for an institutional payment plan for a non-term school.

Some academic institutions offer degree or certificate programs for studies that do not follow the traditional academic year calendar. For example, the school may offer an 18-month program that is divided into three academic years of 30 weeks each, as opposed to a traditional degree program that takes 4 years to complete and is divided into 4 academic years of 9 months.

Determining financial aid estimates for these institutions entail breaking the program of study cost and duration into packaging cycles. The number of cycles to package is determined by the academic year definition provided by the institution. For these institutions, an academic year can be defined in units of weeks, months, courses, clock hours, and/or credits.

To account for scenarios where the academic year does not meet the traditional academic year calendar or the definition provided by the institution, the student aid estimation engine 114 calculates a prorated award amount for some financial aid programs (such as the Pell Grant) in order to account for an abbreviated or extended academic year and to distribute awards to meet the potential student's cost of attendance as determined per academic year. This requires the calculation of prorated Estimated Family Contribution (EFC) to determine the financial need to award some financial aid programs (such as Direct Subsidized or Federal Supplemental Education Opportunity Grant).

For these non-term programs of study, the student aid estimation engine 114 calculates a prorated award amount for some financial aid programs (such as the Pell Grant) in order to account for an abbreviated academic year and to distribute awards to meet the potential student's cost of attendance as determined per academic year.

Additionally, in some cases, the academic institution provides alternative funding of the net price in the form of institutional payment plans. For example, the total payment plan balance 1050 is equal to the program remaining balance for the potential student. To calculate the monthly payment amount 1052, the total payment plan balance 1050 is divided over a payment period defined by the academic institution. Generally, the payment period is the duration of degree/program plus an extended period post-graduation period. In this example, the repayment period is 76 months, which results in a monthly payment of $1,074.

Additionally, the academic institution is able also to apply an interest rate when calculating the monthly payment amount 1052 for institutional payments.

FIG. 1 OF shows an exemplary personal affordability analysis screen 1060 that enables potential candidates to further understand the total costs of obtaining a degree.

The personal affordability analysis screen 1060 enables potential students to explore “what-if” scenarios and adjust funding options and sources to help the potential student determine the best (and worst) ways to fund their education.

The affordability analysis calculator 1061 provides students with projections of the total amount borrowed for student loans 1074, the amount borrowed for parent loans 1076, capitalized interest for the student and parent loans 1084, 1086, and monthly loan payments upon graduation 1080, 1082. Additionally, the affordability analysis calculator 1061 also displays the weighted interest rates 1088, 1090 of the loans, the repayment period (or loan term) 1092, 1094 for the student and parent loans, and the estimated annual growth 1065. In a typical implementation, the original values calculated by the affordability analysis calculator 1061 are saved to the database 110. The original values are saved to enable students, the academic institution, or the computer system edit, review, analyze, or allow the student to continue to experiment with funding options in the future.

The affordability analysis calculator 1061 also includes entry fields 1070, 1072 for the student to include additional amounts funded through income and savings. The amount funded through income and savings 1070, 1072 represents additional funds that the student or their family include in addition to the other funding sources to help reduce the total amount borrowed 1074, 1076. Changes made to the additional amounts funded through income and savings entry fields 1070, 1072 are applied to loans with higher interest rates. For example, these additional amounts would be applied to reduce Stafford subsidized loans before Perkins loans and therefore has the effect of reducing the weighted interest rate.

Additionally, students with existing loan debt is entered in the total amount of loans they have already borrowed to receive a more accurate assessment of their post-graduation debt burden. The pre-existing loan debt is added to the estimated loan amount they would have to borrow to complete their degree and figured through the computer system 106 to calculate the expected monthly loan payments.

The interactive affordability analysis calculator 1061 allows potential students to adjust the different factors used to calculate the monthly loans payments after graduation 1080, 1082. Changes made to the values of the entry fields within the user interface result in a recalculation and the results of the recalculation are displayed in the user interface. By changing the amounts of the entry fields and seeing the recalculations performed and displayed in real-time allows the student to gain a better understanding how changes affect the total amount of money borrowed 1074, 1076, the weighted interest rate 1088, 1090, capitalized interest 1084, 1086, and the monthly loan repayment upon graduation 1080, 1082. In this way the student candidate is able to test different funding scenarios and make decisions how much income and savings to deploy to educational expenses, for example.

The affordability analysis calculator 1061 further includes an entry field to adjust the compound annual growth rate 1065. The compound annual growth rate is used to represent the historical cost increases as a numerical value. The compound annual growth rate is a numerical percentage that is applied to factors such as the published cost of attendance 1004 to determine an estimated total cost of obtaining a degree 1042, total amount of student loans 1044, and total amount of private loans 1044 to list a few examples.

Additionally, the affordability analysis calculator 1061 includes a reset to my original values button 1073 that enables the student to reset all values back to their original amount regardless of how many different changes the student has made any of the entry fields.

FIGS. 10G-10I illustrate examples of changes made to entry fields within the user interface of the affordability analysis calculator 1061.

In FIG. 10G, changes have been made to fields for amount funded through savings and income for the student 1070 and the parent 1072 by adjusting the values in the entry fields 1070, 1072. The computer system 106 applies these additional funds to the loans with the highest interest rates and calculates the total amounts borrowed 1074, 1076, weighted interest rates 1088, 1090, capitalized interest amounts 1084, 1086 and monthly loan payments after graduation 1080, 1082.

In an alternative embodiment, the additional values added to the amounts funded through savings and income entry fields 1070, 1072 causes a recalculation of the weighted interest rates. Similarly, the change to the weighted interest rates 1088, 1090 will then also be factored into the capitalized interest 1084, 1086 and monthly loan payment upon graduation 1080, 1082.

In FIG. 10H the weighted interest rate of the student loans 1088 is reduced from 5.835% to 4% in the specific example illustrated. The reduction in the weighted interest rate 1088 causes a recalculation of the capitalized interest 1084 and the monthly loan payment after graduation 1080.

FIG. 10H further illustrates how multiple changes to multiple entry fields within the user interface can be performed together to see how different combinations of changes made to multiple entry fields affect the other values displayed by the user interface of the affordability analysis calculator 1061. For example, by changing the weighted interest rate of the student loan 1088 in additional to the $1,000 from income and savings 1070, the monthly loan payments after graduation is reduced by almost $46 per month, which translates into over $5,500 savings over the term of the loan.

In FIG. 10I, the monthly loan payment after graduation 1080 for the student loan 1080 is reduced to $400 a month. Changes to the monthly loan payment after graduations 1068 cause the computer system 106 to recalculate and display the new repayment period in the loan term entry field 1092. For example, the monthly loan payment after graduation 1080 was reduced from $579 per month to $400 per month. This change caused the computer system 106 to recalculate the length of amortization algorithm based on the new monthly payment. In the illustrated example, the reduction in payment resulted in an additional 8 years to repay the loan. Similarly, an increase in monthly loan payments (not shown) results in a shortened loan term.

Lastly, the affordability analysis calculator 1061 also performs a validity check to ensure that valid data are entered into the fields, for example, that numbers have been entered into the loan term 1066. Likewise, the affordability analysis calculator 1061 may include rules that require, for example, the loan term 1092, 1094 must be in integers (for complete years) or that the weighted interest rate 1064 cannot be more than a predefined (but configurable) interest rate.

FIG. 10J another embodiment of the affordability analysis calculator 1061 that provides for the inclusion of existing student loans. The net price calculator 108 of the computer system 106 factors in prior loan debt value and interest rate for continuing or transfer students. The interest rate reported is used to calculate the capitalized interest on prior loans. Existing loans are combined with estimated loans and applied to the calculation of monthly loan payments upon graduation.

In more detail, the potential student reports existing loan values 1095, 1097 and interest rates 1096, 1097, which are used recalculate the Total Amount Borrowed 1074, 1076 and Weighted Interest Rates 1088, 1090 resulting in a modified Monthly Loan Payment After Graduation 1084, 1086.

In this embodiment, students is also asked if their current education loan balance includes federal student loans in an effort to inform students of the maximum aggregate federal student loan limit and how those limits impact their ability to borrow additional federal loan amounts and calculate an accurate post graduation monthly loan payment amount.

In operation, the user enters the remaining principle value of Stafford loans in field 1095 and the average interest rate is entered into field 1096. Further the remaining principle for private loans is entered into field 1097. The calculator 1061 sums these two numbers to provide the total remaining student loans principle in field 1098.

These preexisting loan amounts entered into fields 1095 and 1097 are added into the total amount borrowed amounts. The affordability analysis calculator 1061 provides students with projections of the total amount borrowed for student loans 1074, the amount borrowed for parent loans 1076. The totals include the contributions of the existing loan amounts entered in fields 1095 and 1097. The capitalized interest amounts reported in fields 1084 and 1086 and the monthly payment amounts in fields 1080 and 1082 also include both the amount of the existing loans and the new loans that the student is expected student to take.

FIG. 11 is a flowchart that shows the steps performed by the computer system 106 and net price calculator engine 108 to determine the net price calculation results.

In the first step 1204, the computer system gathers survey information from the database 110. In the next step 1206, the computer system 106 determines the candidate's eligibility for scholarships, grants, and loans based on the information entered by the candidate using the student aid estimation engine 114.

In the next step 1208, the computer system calculates expected family contributions. The expected family contribution is how much money a student's family is expected to contribute to the student education. This amount varies from family to family because it is based on a variety of factors that determine a family's financial strength. Some factors for determining the family's financial strength include net assets, liabilities, earned income, numbers of members of a household, and other family members currently attending college. Generally, there are several different formulas to calculate expected family contributions: Institutional Methodology and Federal Methodology. The Institutional Method varies from college to college because each university is able to determine their own methodology to calculate expected family contributions. Conversely, the Federal Methodology is standardized for all schools and determined by the Federal Government.

In the next step 1210, the computer system 106 derives values from entered data. Based on the derived values the computer system 106 will perform pre-eligibility calculations in step 1212. The pre-eligibility calculations are part of a pre-screening process to determine if the candidate meets the basic requirements for the different grants, scholarships, and loans. The computer system then determines the cost of attendance for the academic institution in step 1214.

In the next step 1216, the computer system 106 determines an admission rating. This is an alternative embodiment and this step is only applicable if the academic institution utilizes an admissions rating system/calculation to determine eligibility for an institutional aid program, percent of need met/max gap practices, or any other means of awarding aid. Institutions can use any variables to calculate an admissions rating for prospective students. Some common variables include the students' academic performance, such as GPA, SAT and/or ACT scores, proximity to the institution, the high school the student graduated from, or a student's EFC/need, to list a few examples. Likewise, in an alternative embodiment, other factors such as whether the student is an in-state or out of state resident or was in the military could also be used to determine admission rating.

In the next step 1218, the computer system 106 determines federal eligibility and pre-awards. The computer system then determines if the candidate is a state resident in step 1220 based on the information entered by the candidate. If the candidate is a state resident and the program of study they selected participates in state student aid programs, then the computer system 106 determines state eligibility in step 1222. If the candidate is not a state resident, then the computer system 106 determines college specific eligibility in step 1224.

In the next step 1226, the school organizes the order in which the loans, scholarships and grants are dispersed based on the amount available to give to candidates. The ordering is done because academic institutions only have a finite amount of resources available to give to students.

In the next step 1228, the computer system 106 calculates the total award for each candidate. The total award amount is calculated up to the cost of attending the academic institution. This is to ensure that no student ever receives more financial aid than the total cost of attending the academic institution. In the next step 1230, these calculations are saved to the database 110. Lastly, in step 1232, the information is presented to the candidate on the academic institution's website 112.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method for determining costs of attending an academic institution to complete an educational program, the method comprising:
generating a user interface that enables entry of candidate financial information into a computer system;
the computer system determining and displaying a first year loan amount for the candidate from the candidate financial information;
the computer system generating an estimated total loan amount for the candidate to complete the educational program based on the first year financial aid loan amount and a compounded annual growth rate; and
the computer system displaying the estimated total loan amount along with estimated monthly loan payments that are calculated based on the estimated total loan amount.

2. The method according to claim 1, further comprising displaying a weighted interest rate for the estimated total loan amount, a repayment period for the monthly loan payments, estimated increase in costs, and a total amount of capitalized interest.

3. The method according to claim 2, wherein the user interface displayed by the computer system includes an entry field for the candidate to change an amount of money available to contribute to the cost of the educational program.

4. The method according to claim 3, wherein changes to the amount of money available to contribute to the cost of the educational program causes a recalculation of the estimated total loan amount and estimated monthly loan payments and the results of the recalculation are displayed by the user interface.

5. The method according to claim 2, wherein the user interface displayed by the computer system includes an entry field for the candidate to change the estimated monthly loan payments.

6. The method according to claim 5, wherein changes to the estimated monthly loan payments cause a recalculation of the repayment period and the results of the recalculation are displayed by the user interface.

7. The method according to claim 1, wherein the estimated total loan amount is a summation of federal student loans and parent loans and private/alternative loans borrowed by the candidate.

8. The method according to claim 1, wherein candidate financial information includes earned incomes, investment income, assets, savings, and debts and liabilities.

9. The method according to claim 1, wherein the user interface displayed by the computer system includes an entry field for the candidate to change an amount of money available to contribute to the cost of the educational program and wherein increases in the amount of money available to contribute to the cost of the educational program is applied to loans with higher interest rates.

10. The method according to claim 9, wherein a weighted interest rate is modified in view of the application of the money available to contribute to the cost of the educational program to the loans with higher interest rates and new estimated monthly loan payments are calculated and displayed to the candidate.

11. The method according to claim 1, further comprising displaying parental/family total loan amount with estimated monthly loan payments for parental/family loans.

12. The method according to claim 11, wherein changes to an amount of money available to contribute to the cost of the educational program by the candidate for the parent loans causes a recalculation of the estimated total loan amount and estimated monthly loan payments for the parent loans and the results of the recalculation are displayed by the user interface.

13. A computer system for determining costs of attending an academic institution to complete an educational program, the computer system receiving candidate financial information via a user interface displayed on a screen of a computer system; the computer system conveying the affordability of the educational program for individual prospective student by determining and displaying a first year financial aid loan amount for the candidate from the financial information inputted, generating an estimated total loan amount for the candidate to complete the educational program based on the first year financial aid loan amount and a compounded annual growth rate, and displaying the estimated total loan amount along with estimated monthly loan payments that are calculated based on the estimated total loan amount.

14. The computer system according to claim 13, wherein the computer screen displays a weighted interest rate for the estimated total loan amount, a repayment period for the monthly loan payments, estimated increase in costs, and a total amount of capitalized interest.

15. The computer system according to claim 14, wherein the user interface displayed by the computer system includes an entry field for the candidate to change an amount of money available to contribute to the cost of the educational program.

16. The computer system according to claim 15, wherein changes to the amount of money available to contribute to the cost of the educational program by the candidate and/or the candidates family causes a recalculation of the estimated total loan amount and estimated monthly loan payments and the results of the recalculation are displayed in the user interface.

17. The computer system according to claim 14, wherein the user interface displayed by the computer system includes an entry field for the candidate to change the estimated monthly loan payments.

18. The computer system according to claim 17, wherein changes to the estimated monthly loan payments cause a recalculation of capitalized interest and repayment period and the results of the recalculation are displayed by the user interface.

19. The computer system according to claim 13, wherein the estimated total loan amount is a summation of federal loans and loans borrowed by the candidate and/or the candidate's family members.

20. The computer system according to claim 13, wherein candidate and family financial information includes earned incomes, investment income, assets, savings, and debts and liabilities.

21. The computer system according to claim 13, wherein the user interface displayed by the computer system includes an entry field for the candidate to change an amount of money available to contribute to the cost of the educational program and wherein increases in the amount of money available to contribute to the cost of the educational program is applied to loans with higher interest rates.

22. The computer system according to claim 21, wherein a weighted interest rate is modified in view of the application of the income and savings to the loans with higher interest rates and new estimated monthly loan payments are calculated and displayed to the candidate.

23. The computer system according to claim 13, further comprising displaying total loan amount with estimated monthly loan payments for loans from family.

24. The computer system according to claim 23, wherein changes to an amount of money available to contribute to the cost of the educational program by the candidate for the loans from family causes a recalculation of the estimated total loan amount and estimated monthly loan payments for the loans from family and the results of the recalculation are displayed by the user interface.
